(19) United States
(12) Patent Application Publication
(10) Pub. No.: US 2018/0123629 A1
(43) Pub. Date: May 3, 2018

(54) SMART-RING METHODS AND SYSTEMS

(71) Applicant: CAYLEY WETZIG, San Francisco, CA (US)

(72) Inventor: CAYLEY WETZIG, San Francisco, CA (US)

(21) Appl. No.: 15/098,303

(22) Filed: Apr. 13, 2016

Related U.S. Application Data
(60) Provisional application No. 62/146,404, filed on Apr. 13, 2015.
(60) Provisional application No. 62/207,242, filed on Aug. 19, 2015.

(51) Int. Cl. H04B 1/3827; H04L 29/08

(52) U.S. Cl. CPC H04B 1/385; H04L 67/02; H04L 67/10; H04L 67/24

(57) ABSTRACT

In one aspect, a computerized smart ring embedded with electronics, software, sensors and connectable to another computing system to exchange data includes a ring. The ring includes a computer memory that stores a user vehicle location information, a user biometric information, a plurality of biometric information from a user wearing the ring, a set of biometric sensors that obtains the plurality of biometric information from the user wearing the ring. A computer processor obtains the user vehicle location information, the user biometric information, and the plurality of biometric information from the user wearing the ring. The computer processor implements a local network module that communicatively couples with the other computing system using a Bluetooth® wireless protocol. The computer processor implements a location module that obtains a current user location and a current user location. The computer processor implements an emergency alert module that generates an alert when the plurality of biometric information from the user wearing the ring is greater than a specified threshold. The computer processor implements a haptic interface module that provides haptic instructions to the user.

### CROSS-REFERENCE TO RELATED APPLICATIONS

This application is a claims priority from provisional U.S. Application Provisional No. 62/146,404 filed 13 Apr. 2015. This application is hereby incorporated by reference in its entirety. This application is a claims priority from provisional U.S. Application Provisional No. 62/207,242 filed 19 Aug. 2015. This application is hereby incorporated by reference in its entirety.

### FIELD OF THE INVENTION

This application relates generally wearable computing systems, and more specifically to a system, article of manufacture and method of smart rings.

### DESCRIPTION OF THE RELATED ART

Wearable computing systems are increasing in popularity and use. Additionally, the size of computing systems, sensors and the like are decreasing. Accordingly, various mobile device functionalities can now be implemented in devices that are smaller than smart phones and worn by a user. For example, a smart ring can include computing systems, sensors, networking and output mechanisms.

### BRIEF SUMMARY OF THE INVENTION

In one aspect, a computerized smart ring embedded with electronics, software, sensors and connectable to another computing system to exchange data includes a ring. The ring includes a computer memory that stores a user vehicle location information, a user biometric information, a plurality of biometric information from a user wearing the ring, a set of biometric sensors that obtains the plurality of biometric information from the user wearing the ring. A computer processor obtains the user vehicle location information, the user biometric information, and the plurality of biometric information from the user wearing the ring. The computer processor implements a local network module that communicatively couples with the other computing system using a Bluetooth® wireless protocol. The computer processor implements a location module that obtains a current user location and a current user location. The computer processor implements an emergency alert module that generates an alert when the plurality of biometric information from the user wearing the ring is greater than a specified threshold. The computer processor implements a haptic interface module that provides haptic instructions to the user.

### BRIEF DESCRIPTION OF THE DRAWINGS

FIG. 1 illustrates an example schematic view of a smart ring system, according to some embodiments.

FIG. 2 illustrates an example configuration of hardware and/or software utilized by removable computerized device, according to some embodiments.

FIG. 3 is a block diagram of a sample computing environment that can be utilized to implement various embodiments.

FIG. 4 depicts computing system with a number of components that may be used to perform any of the processes described herein.

The Figures described above are a representative set, and are not an exhaustive with respect to embodying the invention.

### DESCRIPTION

Disclosed are a system, method, and article of manufacture of a smart-ring computing system. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Definitions

Bluetooth is a wireless technology standard for exchanging data over short distances (e.g. using short-wavelength UHF radio waves in the ISM band from 2.4 to 2.485 GHz[4]) from fixed and mobile devices, and building personal area networks (PANs), etc. Bluetooth or any other communication transmitter to a receiver.

Digital camera can be a camera that encodes digital images and videos digitally and stores them for later reproduction.

Haptic technology can interface with the user through the sense of touch.

Mobile device can be a small computing device (e.g. small enough to be handheld and/or wearable). Some mobile devices can include a display screen with touch input and/or a miniature keyboard. Example mobile device can include, inter alia, smart phones, tablet computers, head-mounted displays, augmented-reality systems, virtual-reality systems, wearable computer systems (e.g. smart watches, smart rings, etc.), etc.

Ring can be a circular, decorative or symbolic ornament worn on fingers, toes, arm and/or neck.

Wearable computers, also known as body-borne computers or wearables are miniature electronic devices that are worn under, with or on top of clothing.

### Exemplary Systems and Methods

In one embodiment, a smart ring can be a wearable ring that includes a computing system and various other digital devices. The smart ring can include digital cameras, user input systems, vibration motors, flash, positional sensors, pedometers, networking systems, microphones, geo-location systems, chemical sensors, etc. The smart ring can be communicatively coupled with a mobile device. Information obtained by the smart ring can be communicated to a local mobile device and/or be uploaded to entities (e.g. remote servers) via the Internet. It is noted that in some embodiments, anywhere there is “removable hardware”, there is also a key that will only fit the hardware and covers so others can't remove and copy the particular assembly in question. In some example embodiments, attachable Hardware/sensors and systems herein can be modified for the following women's products: hardware in women's hair extensions; hardware on women's artificial nails; hardware on women's nail art; hardware on women's false eye lashes; hardware/Sensors on women's lipstick; etc.

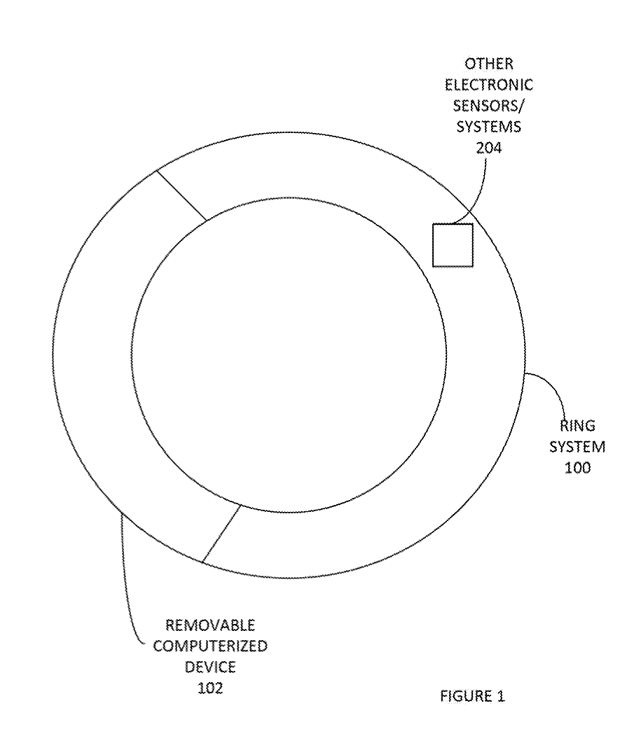

FIG. 1 illustrates an example schematic view of a smart ring system 100, according to some embodiments. Smart ring 100 can include a removable computerized device 102. Removable computerized device 102 can include the various systems provided in the example supra. Removable computerized device 102 can be removed from smart ring system 200 for upgrades, replacement, repairs, and the like.

Removable computerized device 102 can obtain a user's positional information including hand/arm motions patterns. Removable computerized device 102 can recognize various motion patterns and interpret said patterns as explicit and/or implicit user input. For example, specified hand motion can be interpreted by removable computerized device 102 to communicate user pedometer information to a local user's mobile device.

As provided infra, some user motion and/or speech patterns can also be implicitly interpreted by removable computerized device 102. Removable computerized device 102 can include instructions (e.g. in the memory of a computing system in removable computerized device 102) for interpreting various user input and translating said input into various pre-defined actions. For example, removable computerized device 102 can include various sensors for detecting that the user (i.e. a wearer of removable computerized device 102) is in an emergency situation. For example, certain motion and sound patterns can indicate within a specified probability that the user may be experiencing a physical attack by an assailant. Specified sound patterns can include user screams, code works, etc. Removable computerized device 102 can utilize various sensors (e.g. microphones, digital cameras, etc.) to obtain images, audio recordings, etc. of the attack. Removable computerized device 102 can then upload this information to a remote server (e.g. via the user's mobile device, etc.). It is noted that smart ring 100 security information (e.g. that an attack is in progress) can be communicated to a local hardware device communicatively secured with a local law enforcement server. In this way, a local law enforcement officer patrol. The user's location information can be included in the communication. In this way, a local patrol officer can locate the attack and respond accordingly.

In some embodiments, a touch-input surface can be provided. The touch-input surface can recognize user input patterns that can be translated to various system commands.

It is noted that smart ring 100 can also include other integrated computing systems (e.g. touch pad and/or tap sensors, finger-print readers, digital cameras, digital cameras covers, etc.) that are not a part of removable computerized device 102.

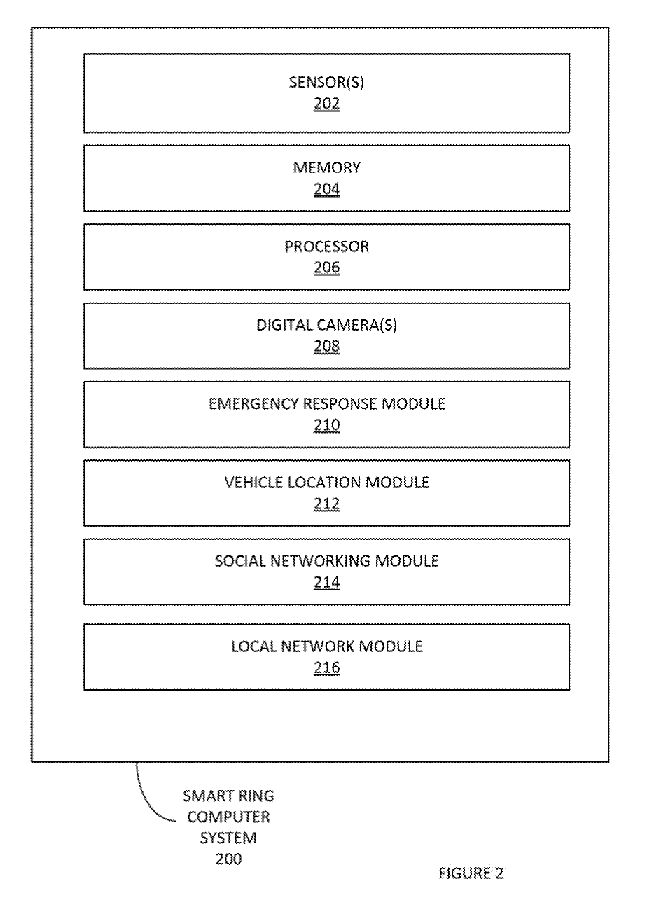

Removable computerized device 102 can include various software (e.g. operating systems, drivers, etc.) that manages computer hardware and software resources. Various applications can run in removable computerized device 102 and/or be stored a local memory system. FIG. 2 illustrates an example configuration 200 of hardware and/or software utilized by removable computerized device 102, according to some embodiments. Configuration 200 can include additional modules and/or other systems (e.g. transceivers, computer buses, etc.) not shown for reasons of simplicity. Configuration 200 can include sensors 202 such as those provided supra. Additional sensors include, inter alia, galvanic skin response sensors (e.g. to detect a user's stress level), pulse/heart rate sensors, pheromone sensors, etc. Configuration 200 can include computer memory 204. Various processes and/or examples provided herein can utilize memory 204. Configuration 200 can include one or more computer processor(s) 206 that executes the various processes and/or examples provided herein. Configuration 200 can include digital camera(s) 208. Digital camera(s) 208 can be located in various positions about smart ring system 100. For example, a digital camera can be located in a position such that a user can take photographs of herself. In another example, a digital camera can be located to obtain outward facing digital images. In yet another example, a digital camera can be located on the interior surface of the smart ring to obtain digital images of a user's skin. Images of the user's skin can be analyzed to determine various user attributes (e.g. pulse, blood pressure, etc.).

Configuration 200 can include an emergency response module 210. Emergency response module 210 manage the detection of an emergency situation. For example, various microphone, user movement, user geo-location and/or other information can be analyzed by emergency response module 210. Based on this information, emergency response module 210 can determine that determine that an emergency situation exists within a specified probability threshold. The probability threshold can various depending on user geo-location (e.g. in a high crime neighborhood), time of day (after ten p.m.), user is alone, and or other factors. Emergency response module 210 can include various machine-learning systems to learn and make predictions from incoming information. Optionally, the user can curate an alertness level for emergency response module 210. For example, a user can set the emergency response module 210 to ‘high alert’. In this mode, a scream and/or several sudden hand jerking motions in rapid succession can cause the emergency response module 210 to begin obtaining digital images and/or audio recordings that are uploaded to a remote server via the Internet and/or a cellular network (e.g. via a user's smart phone). In one example, a user can manually initiate an emergency response process (e.g. by tapping touchpad portion of the smart ring a specified number of times, in a specified pattern, specified verbal input, etc.). When an emergency situation is detected, emergency response module 210 can send the user's location and/or other relevant information (e.g. images, audio recordings, etc.) to a third-party server and/or a local law enforcement server.

Configuration 200 can include vehicle location module 212. Vehicle location module 212 can assist user in finding her vehicle. A user can leave a beacon device in a vehicle. The beacon device can include systems for geo-locating its location. In one example, the beacon device can be a Bluetooth® low energy device that couples with the Internet via a networking device in the vehicle. In other examples, a geo-location device integrated into the vehicle can be utilized to obtain the vehicle's geo-location.

Smart ring system 100 can include various systems (e.g. vibrating motors, speakers, LED lights, etc.) for directing the user to the vehicle's geo-location. For example, smart ring system 100 can include speakers for providing verbal instructions to the user. In another example, smart ring system 100 can use coded haptic signals to direct the user the vehicle. For example, one short vibration can instruct the user to continue straight. Two short vibrations can instruct the user to turn right. Three short vibrations can instruct the user to turn left. One long vibration can inform the user that she has arrived at the vehicle. These are examples and not provided by way of limitation. Other haptic patterns can be provided in various other examples. In still yet other examples, combinations of sounds, haptics and/or LED light patterns can be utilized.

Optionally, some example configurations of system 200 can include a social networking module 214. Social networking module 214 can access various online social networking APIs (e.g. Facebook®, Twitter®, Snapchat®, Instagram®, etc.). Social networking module 214 then generate a list of the user's social network. Social networking module 214 can use geo-location (e.g. via a remote server functionality) to determine if other members of a user's social network(s) are within a specified distance (e.g. in the same room, within twenty meters, etc.). For example, social networking modules in each smart ring can track the geo-location of all users who opt in to social networking functionalities. Upon detection of a nearby social network member, social networking module 214 can alert the user (e.g. via sounds, haptic feedback, visual cues, etc.). Social networking module 214 can guide the nearby users to each other for in-person meetings.

Local network module 216 can manage computer networking for smart ring system 100. Local network module 215 can use Bluetooth® and/or other local Wi-Fi networks to connect to a user's mobile device. Local network module 216 can then utilize the mobile device as a proxy for communicating to other mobile devices and/or remote servers (e.g. via an application in the user's mobile device).

It is noted that in some examples, various functionalities of configuration 200 can include be offloaded to a local smart phone and/or remote server. For example, machine learning and/or other analytics can be performed by an application in a smartphone based on information obtained by configuration 200. Additionally, some of the systems/modules of configuration 200 can include can be implemented in a local mobile device.

Additionally, smart ring system 100 can be decorative. For example, it can include various metallic and jewel decorations. In some examples, smart ring system 100 can be implemented (in whole or in part) in other formats such as bracelets, earrings, toe rings, etc. Smart ring system 100 can be implemented a ‘clip-on’ device that attaches to a ring.

Smart ring system 100 can include an activity tracker application. The activity tracker application can monitor and track fitness-related metrics such as distance walked or run, calorie consumption, and in some cases heartbeat and quality of sleep. The activity tracker application can be used for long-term data tracking as well. Activity data can be uploaded to the mobile device application and/or a website for review by the user. Smart ring system 100 can include chemical sensors for detecting chemicals emanating from a user's epidermis. In this way, various chemicals consumed by a user can be detected. Alerts can be sent to the user notification systems accordingly. If a user health issue is detected, the user can be notified. Additionally, user health reminders (e.g. medication schedules, blood test schedules, etc.) can be downloaded into the smart ring system. The smart ring system can then provide reminder alerts to the user. This can be done haptically such that the user feels the alarm that is otherwise undetectable to others in the user's presence. In yet another example, smart ring system 100 can detect that a user is asleep and use alerts to awaken the user if the user is performing an activity such as driving or operating machinery or in the user's workplace.

Smart ring system 100 can be connected to the Internet of Things (IOT) such that the user can use input into smart ring system 100 to manage various user appliances, home settings, vehicle settings, etc. For example, a user can use tap and/or voice input to turn on her home lights, open a garage door or unlock a vehicle. User input can be used as one step in a multifactor user authentication process to access the user's appliances, home settings, vehicle settings, etc. (along with other factors such as user presence, passwords, etc.).

### Additional Systems and Architecture

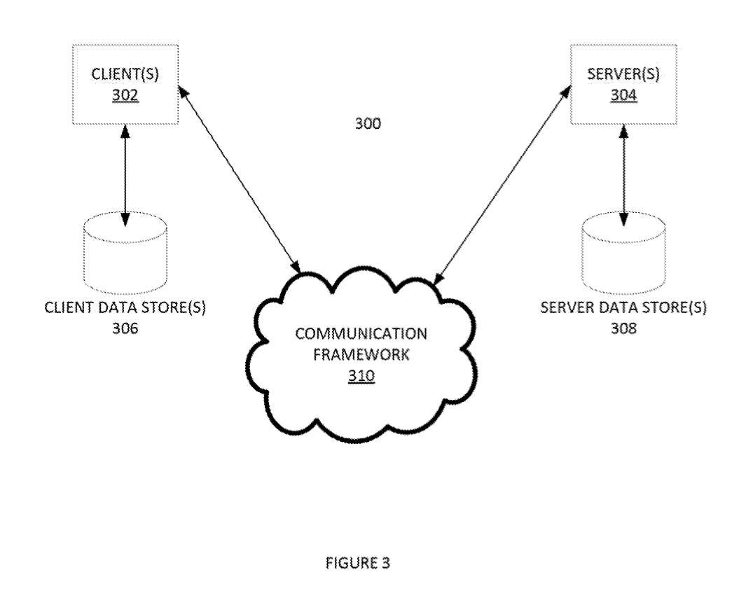

FIG. 3 is a block diagram of a sample computing environment 300 that can be utilized to implement various embodiments. The system 300 further illustrates a system that includes one or more client(s) 302. The client(s) 302 can be hardware and/or software (e.g. threads, processes, computing devices). The system 300 also includes one or more server(s) 304. The server(s) 304 can also be hardware and/or software (e.g. threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304.

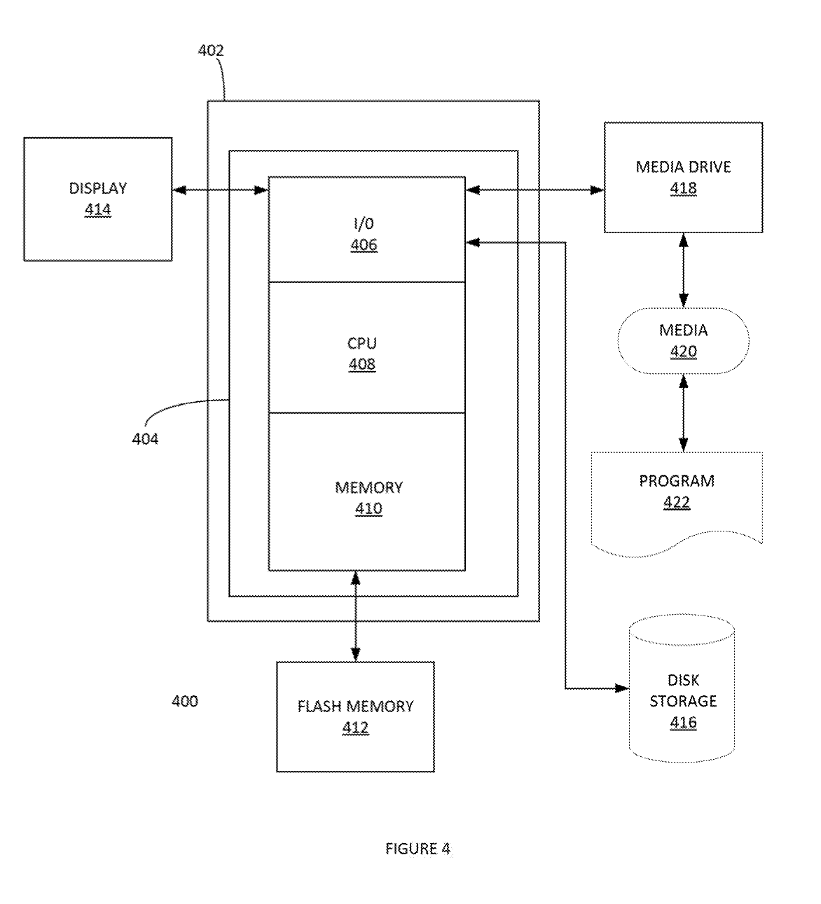

FIG. 4 depicts an exemplary computing system 400 that can be configured to perform any one of the processes provided herein. In this context, computing system 400 may include, for example, processor, memory, storage, and I/O devices (e.g. monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g. embodied in a machine-readable medium).

In addition, it can be appreciated that the various operations, processes, and methods disclosed herein can be embodied in a machine-readable medium and/or a machine accessible medium compatible with a data processing system (e.g. a computer system), and can be performed in any order (e.g. including using means for achieving the various operations). Accordingly, the specification and drawings are to be regarded in an illustrative rather than a restrictive sense. In some embodiments, the machine-readable media can be a non-transitory form of machine-readable medium.

What is claimed as new and desired to be protected by Letters Patent of the United States is:

1. A computerized smart ring embedded with electronics, software, sensors and connectable to another computing system to exchange data comprising:
a ring that comprises:
a computer memory that stores a user vehicle location information, a user biometric information, a plurality of biometric information from a user wearing the ring,
a set of biometric sensors that obtains the plurality of biometric information from the user wearing the ring;
a computer processor that:
obtains the user vehicle location information, the user biometric information, and the plurality of biometric information from the user wearing the ring;
implements a local network module that communicatively couples with the other computing system using a Bluetooth® wireless protocol;
implements a location module that obtains a current user location and a current user location;
implements an emergency alert module that generates an alert when the plurality of biometric information from the user wearing the ring is greater than a specified threshold; and
implements a haptic interface module that provides haptic instructions to the user.

2. The computerized smart ring of claim 1, wherein the set of biometric sensors comprises a microphone, a digital camera, a galvanic skin response sensors and a heart rate sensor.

3. The computerized smart ring of claim 2, wherein the set of biometric sensors comprises a pheromone sensor.

4. The computerized smart ring of claim 3, wherein the plurality of biometric information from a user wearing the ring is used to determine a user alert state.

5. The computerized smart ring of claim 4, wherein the other computing system comprises a user's smart phone.

6. The computerized smart ring of claim 5, wherein the location module that obtains the current user location and the current user location from a location application in the user's smart phone.

7. The computerized smart ring of claim 6, wherein the specified threshold that indicates a state of alarm in the user.

8. The computerized smart ring of claim 7, wherein the haptic interface module provides a set of vibration patterns that guide the user to the user's vehicle.

9. The computerized smart ring of claim 8, wherein the set of biometric sensors are removable from the ring and replaceable by another set of biometric sensors.
